(19) United States
(12) Patent Application Publication
(10) Pub. No.: US 2024/0346131 A1
(43) Pub. Date: Oct. 17, 2024

(54) System, Method, and Apparatus for Whitelisting Installations

(71) Applicant: PC Matic Inc, Sioux City, IA (US)

(72) Inventors: Robert J. Cheng, Myrtle Beach, SC (US); Matthew Quincy Riley, Owosso, MI (US)

(73) Assignee: PC Matic Inc, Sioux City, IA (US)

(21) Appl. No.: 18/299,098

(22) Filed: Apr. 12, 2023

(51) Int. Cl. G06F 21/51; G06F 8/61; G06F 21/55; G06F 21/60

(52) U.S. Cl. CPC G06F 21/51; G06F 8/61; G06F 21/552; G06F 21/604; G06F 2221/033

(57) ABSTRACT

A system and method of synchronizing a whitelist with an installation on a protected device includes detecting an installation and determining which programs are affected by the installation by parsing an installation file. Programs that are being installed by the installation are added to the whitelist; Programs that are being deleted by the installation are removed from the whitelist; and programs that are being modified by the installation are updated in the whitelist. Therefore, after the installation is complete, the whitelist contains entries that will allow execution of programs (executables, scripts, macros, etc.) that were installed by the installation.

### FIELD OF THE INVENTION

This invention relates to computer security and more particularly to a system for automatic whitelisting when installing software packages.

### BACKGROUND OF THE INVENTION

Currently, many software systems attempt to provide a secure computing environment by preventing intrusions. Such systems often use lists of known safe programs (whitelists) and/or lists of known malicious programs (blacklists) to prevent malicious programs from running and affecting the user's device. Any device having a processor (including cellular phones, etc.) that is connected to a network is subject to intrusion from that network.

Today, many intrusions start with reception of malicious software, typically a script or executable. Malicious software is typically a software program that gets installed on the user's computer or device, sometimes without permission or knowledge of the user. In some instances, the malicious software is delivered to the user in an email, typically an attached file, or from a web site. Upon opening of a file or clicking a link, the malicious software is copied onto the user's computer storage and either begins to run or schedules itself to run later.

To prevent such malicious software from infecting a computing environment, some anti-malware software operates on a principle of whitelists. With such, any program that is not on a whitelist (e.g., a list of approved programs) is blocked. Therefore, if a malicious software is introduced to a user's computer, it will likely not be on the whitelist and, therefore, be blocked from executing. A whitelist requires users and/or administrators to constantly update their whitelists to include new programs that are needed/desired for users to perform their tasks. This is a small price to pay for the added security.

Whitelisting provides good security but requires additional administration to add programs/scripts that are needed by various users. Every time a new program is added to a system, a reference to that program must be added to a whitelist for that program to be executed. For example, when tax2022.exe is added to a system, a reference to tax2022 must be added to a whitelist before the user is able to run/execute tax2022.exe.

Now, when a software suite is installed, whitelisting becomes a much more difficult task. Take a popular software suite containing a spreadsheet program, word processor, etc., At last count, this suite included over 42 executable programs. Therefore, for this suite to function properly after installation, all executable programs must be added to a whitelist. Although possible, an information technology professional must be familiar with the software suite, knowing where programs are installed and which programs are installed, then must scan directories for executables to determine what must be added to a whitelist. This process is not always safe as if a malicious program has already been placed in the installation directory for this package, the information technology professional might not realize that this program was malware and added this program to a whitelist.

An easier method of adding program suites to a whitelist will not only simplify the work of the information technology professional, but such a method will also improve accuracy by reducing the addition of suspicious programs to the whitelist while assuring that all required programs are properly added to the whitelist, thereby improving end-user satisfaction.

What is needed is a tool to aid the administrator in managing whitelists when software is installed.

### SUMMARY OF THE INVENTION

A system for intelligent managing of whitelisting during installation provides options to the administrators and/or information technology team to allow administration of whitelists based upon installation scripts. For example, if a software suite includes several executables and several scripts, the administrative software analyzes the installation script and determines which executables and scripts need be added to the whitelist for proper operation of the software suite once installation is complete.

In one embodiment, a system for computer security running on a processor of a protected computer is disclosed including, when the system for computer security determines that an installation is being performed on the protected computer, the system for computer security analyzes an installation file that controls the installation being performed on the protected computer and, for each program being installed by the installation, the system for computer security adds an entry to a whitelist that allows execution of the program that is being installed and for each program being deleted by the installation, the system for computer security removes any previous entry from the whitelist. After the installation is complete, all programs that were installed by the installation are referenced in the whitelist and are allowed to execute.

In another embodiment, system for computer security running on a processor of a protected computer is disclosed including when the system for computer security determines that an installation is being performed on the protected computer, the system for computer security adds a reference to an installation file that controls the installation being performed on the protected computer to a whitelist. After the installation is complete, when a program attempts to run, the system for computer security detects the reference to the installation file in the whitelist and parses the installation file to determine if the program was installed by the installation and if the program was installed by the installation, the program is allowed to run.

In another embodiment, a method of synchronizing a whitelist with an installation on a protected device is disclosed including detecting an installation and determining which programs are affected by the installation by parsing an installation file. Programs that are being installed by the installation are added to the whitelist; Programs that are being deleted by the installation are removed from the whitelist; and programs that are being modified by the installation are updated in the whitelist.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the system for computer security with whitelisting during installation.

FIG. 2 illustrates a schematic view of a typical computer protected by the computer security system with whitelisting during installation.

FIG. 3 illustrates a schematic view of a typical server computer system.

FIG. 4 illustrates an exemplary whitelist of the computer security system.

FIG. 5 illustrates an exemplary installation environment of the prior art.

FIG. 6 illustrates an exemplary installation environment integrated with the computer security system with whitelisting during installation.

FIGS. 7-8 illustrate exemplary program flows of the computer security system with whitelisting during installation.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

In general, a whitelist/blacklist-based computer security system provides an automated way to prevent execution of software containing code that is potentially contaminated (e.g., contains or is malicious software). Before execution of any item (e.g., program or script) on the target computer system, a test is performed by checking one or more whitelists and/or blacklists to determine if the item has been approved (e.g., enabled) for execution (whitelist) or prevented from execution (blacklist) on the target computer system and, if the item is on the blacklist, execution of the code is blocked unless an entry in a whitelist permits execution of the item. It is fully anticipated that there be multiple blacklists and whitelists, for example, a global blacklist, a global whitelist, a company whitelist and/or blacklist, a department-wide whitelist and/or blacklist, a local blacklist, and a local whitelist. Further, any form and location of storage of the blacklist(s) and whitelist(s) are anticipated, including local memory and/or cloud memory.

Throughout this description, the term, “device” refers to any system that has a processor and runs software. Examples of such are: a personal computer, a server, a notebook computer, a tablet computer, a smartphone, a smart watch, a smart television, etc. The term, “user” refers to a human that has an interest in the device, perhaps a person (user) who is using the device.

Throughout this description, the term “directory” or “directory path” describes a hierarchical pathway to a particular folder in which files (e.g., data or programs) are stored for access by the device. For example, “C:/windows/system32” refers to files stored in a folder called “system32” which is a subfolder of another folder called “windows” which is a top-level folder of a storage device known as “C.” Note that the storage device (e.g., C:) is at times a physical device (e.g., a separate disk drive) or a logical device (e.g., a portion of a local or remote storage). Also note that the described representation (e.g., “C:/windows/system32”) is a human-readable representation of such hierarchy used by certain operating systems and any such representation is anticipated and included herein (e.g., some representations use backslashes instead of slashes).

Throughout this description, the term, “malicious software” or “malware” refers to any software having ill-intent. Many forms of malicious software are known; some that destroy data on the host computer; some that capture information such as account numbers, passwords, etc.; some that fish for information (phishing), pretending to be a known entity to fool the user into providing information such as bank account numbers; some encrypt data on the computer and hold the data at ransom, etc. A computer virus is a form of malicious software.

In general, the system, method, and apparatus being described utilizes efficient storage and retrieval mechanisms to determine if an item (e.g., an executable, macro, form, etc.) is identified within a list, either a whitelist or a blacklist. A hash table is one such mechanism, though other mechanisms are equally anticipated and included here within. As an efficient way of characterizing the questionable program, in some embodiments, it is anticipated that rather than storing the entire program in such tables, a portion of the program is stored, often referred to as a signature of the program. For example, the signature contains key sequences found within the program; finding of such key sequences typically indicates that the program matches the signature or a hash value of the program.

Throughout this document, the term program will refer to any item that potentially runs on the device, including, but not limited to software programs, scripts, and macros.

The term “installation file” refers to a control file that directs the installation of a software package/suite/operating system. In general, the installation file includes directives that dictate what folders are to be created and what files are to be placed in folders, as well as modifications that need to be made to operating system files in order for the software package to operate. Note that many installation files also include directives for uninstalling the package, properly removing files and folders and changing the operating systems back to how they were before the installation occurred.

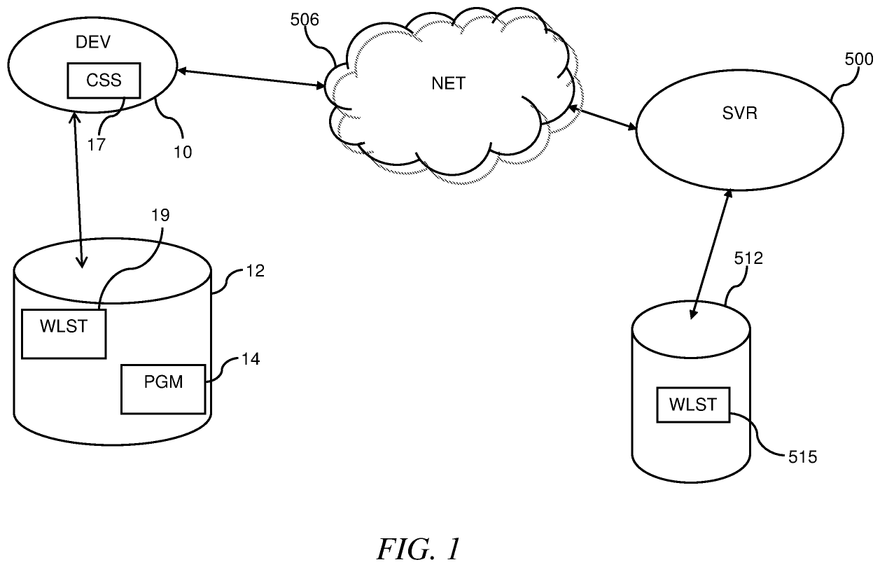

Referring to FIG. 1 illustrates a data connection diagram of the exemplary computer security system with whitelisting during installation. In this example, a target device 10 (e.g., a personal computer that is being protected or a protected device) communicates through a network 506 (e.g., the Internet, local area network, etc.) to a server computer 500.

The server computer 500 has access to data storage 512. Although blacklists are often used to prevent execution of known malware and are fully anticipated, the present invention is concerned with enabling execution of programs that are part of a software installation and, therefore, the present invention deals directly with whitelisting. Therefore, one item in the data storage 512 is a master whitelist 515; for example, a master whitelist 515 of programs/applications that are known to be safe and hopefully free of malware and, therefore, programs that are allowed to execute on devices 10. In some embodiments, the data storage 512 is in the cloud.

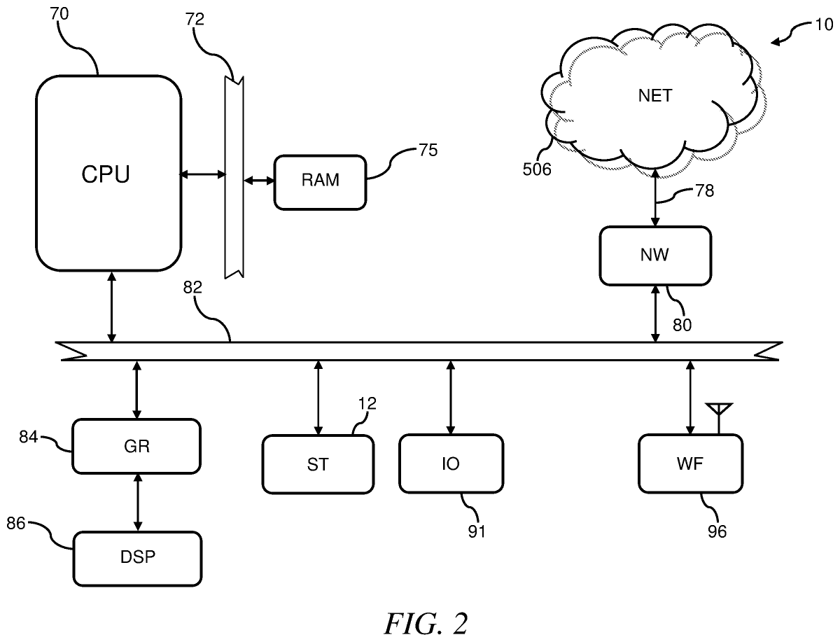

Although one path between the target device 10 and the server computer 500 is shown going through the network 506 as shown, any known data path is anticipated. For example, the Wi-Fi transceiver 96 (see FIG. 2) of the target device 10 is used to communicate with the wide area network 506, which includes the Internet, and, consequently, with the server computer 500.

The server computer 500 transacts with computer security system software 17 that runs on the target device 10 through the network(s) 506. The computer security system software 17 includes whitelisting during installation. The computer security system software 17 runs on the target device 10 and monitors any activation of programs/applications/scripts (e.g., running of a program) and provides or denies permission for running the program/application/script on the target device 10. The program/application/script is allowed to run when the programs/applications/scripts is deemed malware-free (e.g., the program 14 is in the whitelist 19). Information is also transferred from computer security system 17 that runs on the target device 10 to the server computer 500 regarding potential threats, etc.

The server computer 500 transacts with the computer security system software 17 that runs on the target device 10 as needed, for example, to update the whitelist 19 that is stored on the target device 10.

The computer security system software 17 selectively provides execution approval to software (e.g., program 14) that attempts to execute on the target device 10. In such, if approval is provided, the software is able to execute on the target device 10. If approval is not provided, the software is blocked from executing on the target device 10 and various additional steps are taken such as logging the attempt, transferring the suspect software to the server computer 500 for analysis, and informing the user of the target device 10, etc.

Referring to FIG. 2, a schematic view of a typical device 10 is shown. The computer security system software 17 runs on the target device 10 (any processor-based device) for providing protection against programs/applications/scripts that contain malicious software (malware). The present invention is in no way limited to any particular target device 10. Protection for many processor-based devices is equally anticipated including, but not limited to smart phones, cellular phones, portable digital assistants, routers, thermostats, fitness devices, smart watches etc.

The target device 10 shown as an example represents a typical device that is protected by computer security system software 17. This exemplary device 10 is shown in its simplest form. Different architectures are known that accomplish similar results in a similar fashion, and the present invention is not limited in any way to any particular computer system architecture or implementation. In this target device 10, a processor 70 executes or runs programs in a random-access memory 75. The programs are generally stored within a persistent memory, storage 12, and loaded into the random-access memory 75 when needed. The processor 70 is any processor, typically a processor designed for phones. The random-access memory 75 is interfaced to the processor by, for example, a memory bus 72. The random-access memory 75 is any memory suitable for connection and operation with the selected processor 70, such as SRAM, DRAM, SDRAM, RDRAM, DDR, DDR-2, etc. The storage 12 is any type, configuration, capacity of memory suitable for persistently storing data, for example, flash memory, read only memory, battery-backed memory, hard disk, etc. In some exemplary target computers 10, the storage 12 is removable, in the form of a memory card of appropriate format such as SD (secure digital) cards, micro-SD cards, compact flash, etc.

Also connected to the processor 70 is a system bus 82 for connecting to peripheral subsystems such as a cellular network interface 80, a graphics adapter 84 and user I/O devices 91 such as mice, keyboards, touchscreens, etc. The graphics adapter 84 receives commands from the processor 70 and controls what is depicted on the display 86. The user I/O devices 91 provides navigation and selection features.

In general, some portion of the storage 12 is used to store programs, executable code, and data, the whitelist 19, etc. In some embodiments, other data is stored in the storage 12 such as audio files, video files, text messages, etc.

The peripherals shown are examples, and other devices are known in the industry such as Global Positioning Subsystems, speakers, microphones, USB interfaces, cameras, microphones, Bluetooth transceivers, Wi-Fi transceivers 96, image sensors, temperature sensors, etc., the details of which are not shown for brevity and clarity reasons.

In some embodiments, a network interface 80 connects the target device 10 to the network 506 through any known or future protocol such as Ethernet, Wi-Fi, GSM, TDMA, LTE, etc., through a wired or wireless medium 78. There is no limitation on the type of connection used. In such, the network interface 80 provides data and messaging connections between the target device 10 and the server computer 500 through the network 506.

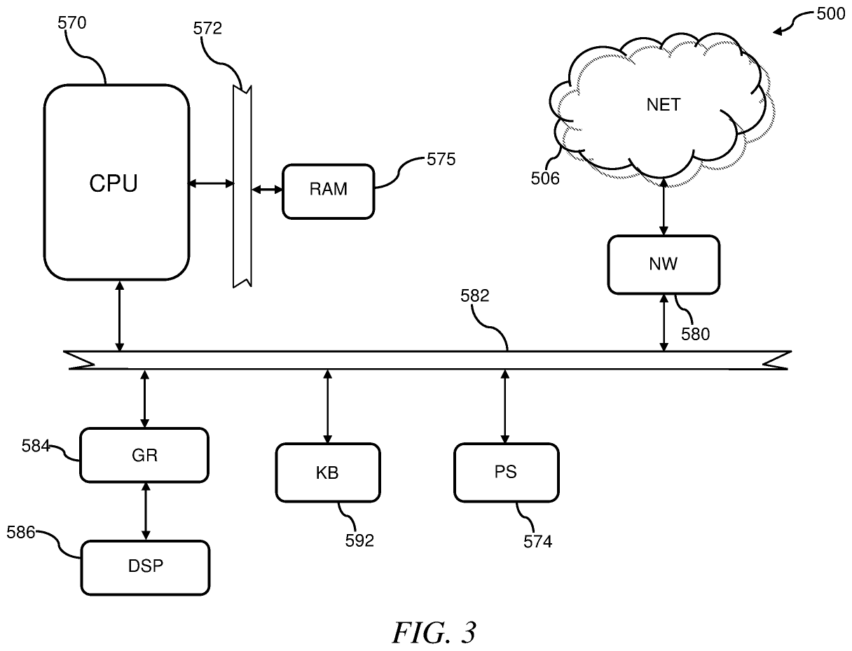

Referring to FIG. 3, a schematic view of a typical server computer system (e.g., server computer 500) is shown. This server computer 500 represents a typical server computer system used for back-end processing, generating reports, displaying data, etc. This exemplary server computer 500 is shown in its simplest form. Different architectures are known that accomplish similar results in a similar fashion and the present invention is not limited in any way to any particular computer system architecture or implementation. In this the server computer 500 includes a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus-USB). The graphics adapter 584 receives commands from the processor 570 and controls what is depicted on a display 586. The keyboard interface 592 provides navigation, data entry, and selection features.

In general, some portion of the persistent memory 574 is used to store programs, executable code, data, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

In the past, after installing a software package or after an update installation is performed, many programs 14 will be missing from the whitelist 19 and, therefore, will be blocked from running until the administrator adds each program/script/macro to the whitelist 19. This is a very tedious activity as there are often many programs 14 that are updated or installed with updates and software installations. Further, it is often difficult to discover which programs were installed or updated after the installation completes, making it very difficult for the administrator to correctly enable (add to the whitelist 19) all programs 14 that were installed or updated and, missing any of the programs 14 that were installed or updated often results in an unhappy user who cannot use the newly installed or updated software.

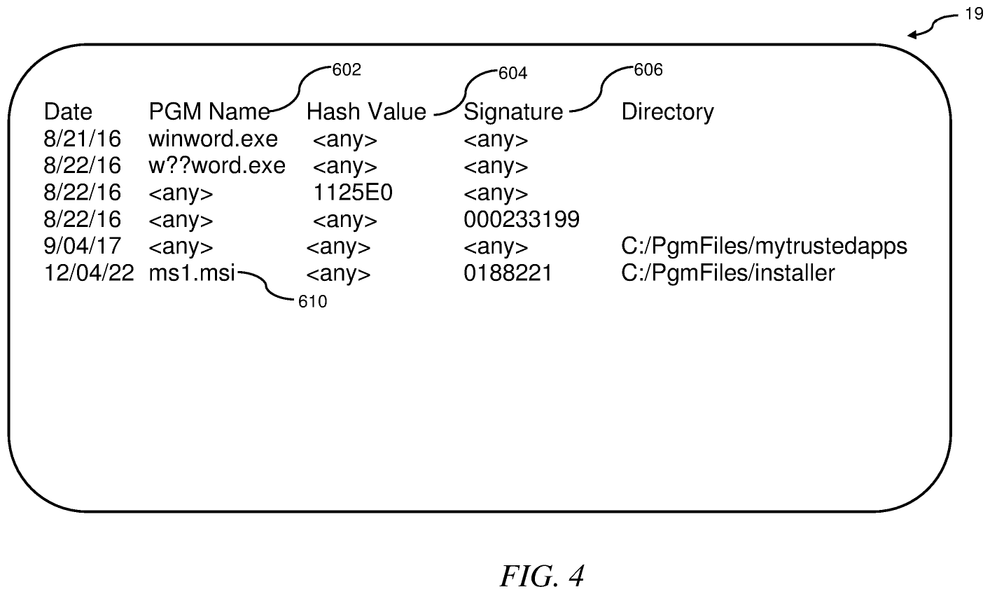

The table of FIG. 4 depicts one implementation of a whitelist 19. For efficiency, it is anticipated that in some embodiments, the whitelist 19 be implemented as a hash table for compact storage and faster access. In some embodiments, there are multiple whitelists 19. In this example, there is a single whitelist 19 arranged in linear fashion with entries for each type of whitelisted element (program or directory).

As an example, using the whitelist 19 of FIG. 4, when an attempt is made to run a program 14, the name of the program 14 is searched in the whitelist 19 (or program name range using wild card or regular expression characters as in “w?? word.exe”). If the program name is found, the program 14 is allowed to run. If the program name is not found, a hash value of the program 14 is calculated and the whitelist 19 is searched for that hash value. Note that hash algorithms are known and well-understood in the field of programming. If the hash value is found in the whitelist 19, the program 14 is allowed to run. Next, the signature of the program 14 is extracted (if the program is signed) and the whitelist 19 is searched for the signature. If the signature is found, the program 14 is allowed to run. If the signature is found, the directory in which the program 14 is located is determined and the whitelist 19 is searched for that directory. If the directory is found, the program 14 is run. Note that any combination of ways to determine if a program 14 is in the whitelist 19 is anticipated and included here within.

In some embodiments, each entry of the whitelist 19 includes information regarding the program or directory such as the date of last change, the name of the program 602, a hash value 604 of the program 14, and a signature 606 of the program 14. In some embodiments, more or less information is maintained in the whitelist 19. Note that as malware becomes more sophisticated, the malware often masquerades as known, valid programs such as word processors. The hash value 604 of the program 14 is one way to prevent this type of masquerading, as a hash value of a malware version (e.g., having the same name as the valid program) will often be different that a hash value 604 of the program 14 that is known to be safe, as the malware version of the program will have different internal coding (e.g., the malicious code). In some embodiments, the hash value 604 of the program 14, for example is based upon a summation/modulus or other numerical calculation based upon the entire program 14 or a portion of the program 14. Any tampering with the program 14 by, for example, a hacker, will change the calculation, resulting in a mismatch between the calculated hash value and the hash value 604 of the program 14 from the whitelist 19, even if a size of the file in which the program 14 is stored matches the size of program that is valid.

In some embodiments, identification is by a signature 606 of the program as provided in the whitelist 19. The signature 606 of the program 14, for example is based upon a probing of the entire program or a portion of the program. For example, the presence or absence of certain strings within the program, values at certain locations within the program, etc. Any tampering with the program 14, for example, by a hacker, will change a calculation of the signature(s), resulting in not finding certain expected values within the signature based upon the signature 606 of the program from the whitelist 19.

In some embodiments, a reference to an installation 610 in the whitelist 19 indicates all programs installed by an installer using an installation file are allowed. In this example, the reference to an installation 610 is to msi.msi. The installation file 52 includes information about what programs (executables, scripts, macros, etc.) were installed. As an example, after using this installation file, an executable called wordprocessor.exe is installed on the target device 10. When the user attempts to executed wordprocessor.exe, the whitelist 19 is checked to make sure this program is allowed. Although, in this example, a direct reference to wordprocessor.exe is not contained in the whitelist 19, when the computer security system software 17 finds the entry for msi.msi, the installer file called msi.msi is opened and parsed to see if wordprocessor.exe is part of this installation and, if it is, then wordprocessor.exe is allowed to run.

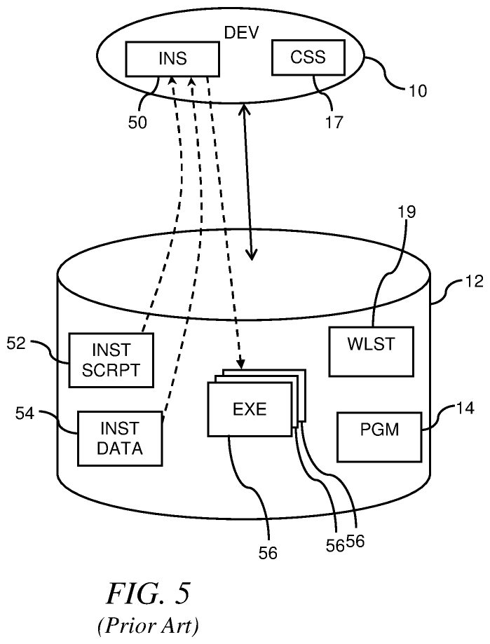

Referring to FIG. 5, an exemplary installation environment of the prior art is shown. Although there are many installer and update systems, each typically includes an installation script or control file (herein referred to as an install file 52) and each has a installation data file 54. The install file 52 is read by the installer 50 (a program running on the device 10) to provide instructions as to how to interpret the installation data file 54 (e.g., how to divide the installation data file into objects) and where to place each of the objects (e.g., what folders to create, what files to install in each folder, what changes need be made to the operating system files (e.g., the registry for some operating system), etc. After the installer 50 reads the install file 52, the installer parses the install file 52 while reading the installation data file 54, depositing programs, data files, scripts, macros, tables, etc., within the storage 12 of the device 10. In this example, several executable files 56 are installed by the installer 50 within the file system of the storage 12.

In the past, after the installation (or update) is complete, the administrator needed to determine which programs (e.g., executables 56) have been installed and add those programs to the whitelist 19. Otherwise, when the user attempts to run one of the executables 56, the executable 56 will be blocked as not being present in the whitelist 19. This task becomes extremely difficult for the administrator as many installations and updates often install hundreds of objects and each object that is to be executed at some time in the future, must be in the whitelist 19.

Policy decisions are often made at a high level. For example, a Microsoft® package is determined to be safe and is properly licensed. Therefore, it is desired to allow this package to be used on a device 10, but with the prior art, the name of the package (e.g., Office 2007) cannot be placed in the whitelist 19 as there is no direct mapping between the name of the package and any particular set of executables, scripts, etc. Without extra work by the administrator, after installing this package, many of the executables and scripts will not run as they do not appear in the whitelist 19.

The present invention utilizes knowledge of known installer packages as an index to programs 14 (e.g., executables, scripts, etc.) that will be allowed to run on the target device 10. This indexing is done either by the computer security system software 17 parsing the install file 52 after installation completes to determine all programs 14 (e.g., executables, scripts, etc.) that are being installed by the installer and adding each program 14, individually, to the whitelist 19. Alternatively, during installation of the package, the name of the package is added to the whitelist 19 and when a program 14 attempts to run, this entry in the whitelist 19 will point to the installation script and the computer security system software 17 will parse the install file 52 to see if the program 14 was installed as part of the package, and if so, allow the program 14 to run.

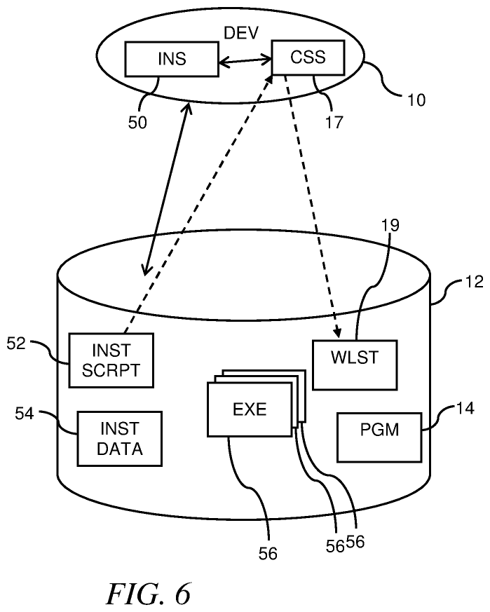

Referring to FIG. 6, an exemplary installation environment integrated with the computer security system software 17 is shown. In this, the computer security system software 17 determines when an Installer/Uninstaller/Update program is run. There are several ways to make this determination:
1) Finding a signature for well-know installers such as MSI or Install Shield.
2) Reading the certificate of any signed executable that runs on the device 10 with respect to the program's current process privilege as installers must run with the authorization to modify the filesystem.
3) Analyzing the metadata of files that the installer places in the storage 12 of the device 10 to correlate the updated files to previously installed files.
4) Manually classify each possible installer, especially those that are hard to identify and classify. This is typically done by a researcher.
5) Provide a custom signing certificate to corporate information technology departments. The custom signed certificate signals the computer security system software 17 as to the policies and which programs 14 are approved.
6) Looking for common installer signatures, as several installers have a common code base.

Looking for programs that access add/remove program application programming interfaces (APIs) as such programs are likely installers. the computer security system software 17 monitors and determines every file that the installer 50 touches. If any such file is an executable (or similar), the computer security system software 17 records such for adding to the whitelist 19. In such, if the application being installed is already known and believed to be safe, then each executable that the computer security system software 17 recorded is added to the whitelist 19.

Once the determination is made, if the installer 50 and the package being installed is approved (e.g., the package defined by the install file 52), the computer security system software 17 determines which programs 14 (e.g., executables 56, scripts, macros) are being added, modified, or removed and the computer security system software with enhanced whitelisting 17 updates the whitelist 19 accordingly by adding entries to the white list for new programs 14 (e.g., executables 56, scripts, macros), updating entries in the whitelist 19 for modified programs 14 (e.g., executables 56, scripts, macros), or removing entries from the whitelist 19 for deleted programs 14 (e.g., executables 56, scripts, macros). In this way, after the installation of an approved software package is complete, the whitelist 19 is fully populated with sufficient permissions as to allow all programs 14 (e.g., executables 56, scripts, macros) in the package to operate properly and not be blocked.

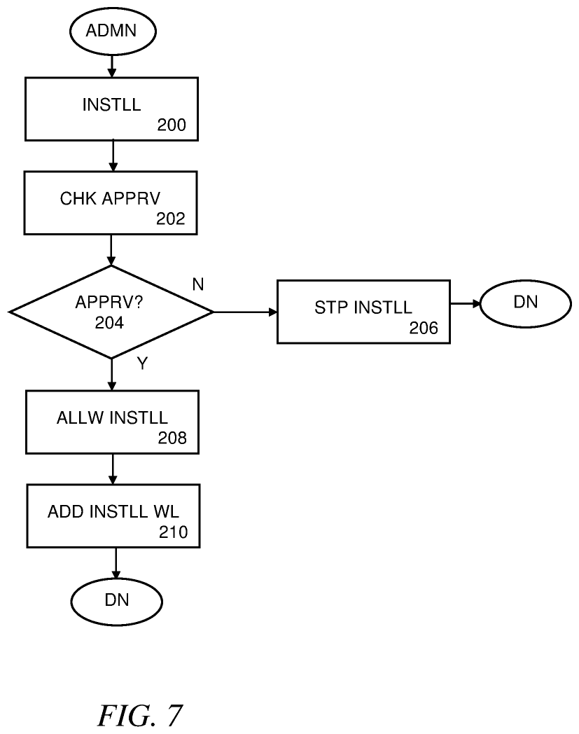

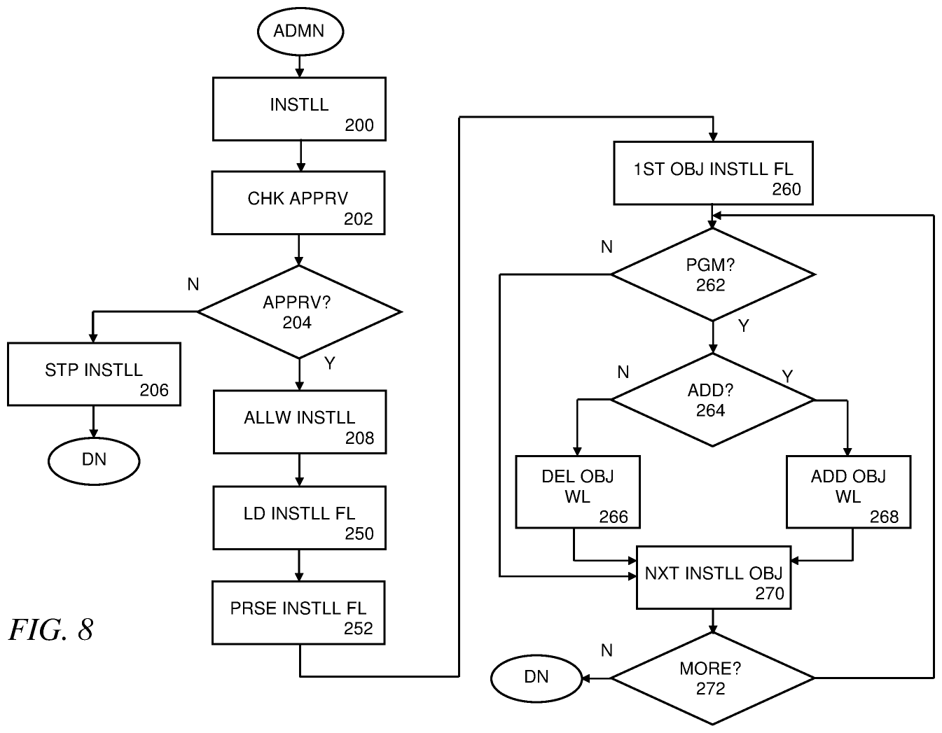

Once an installer 50 is identified and is running on the device 10, the Referring to FIGS. 7 and 8, exemplary program flows of the computer security system software 17 are shown. FIG. 7 shows an embodiment in which a reference to the installation file 52 is added to the whitelist 19. FIG. 8 shows an embodiment in which the installation file 52 is parsed and entries for each object are added to the whitelist 19.

It is anticipated that portions of the exemplary program flow execute on a user device such as the target device 10 while portions of the exemplary program flow execute on the server computer 500 in any combination and on any known computer.

In the example of FIG. 7, the flow starts when an installation 200 is performed. Note that the installation 200 is any of a new installation, a de-installation, or an installation of an update.

Upon receiving notice of the installation, the computer security system software 17 optionally checks to make sure 202 the software package is approved. If the installation is not approved 204, the installation is stopped 206.

If the installation is approved 204, the installation is allowed 208 and reference to an installation 610 is added 210 to the whitelist 19. The reference to the installation 610 points to the install file 52 that was used to perform the installation. Thereafter, upon execution of a program, if the program was installed in this installation, the program will appear in reference to the installation 610 and, therefore, will be allowed to run.

In the example of FIG. 8, the flow starts when an installation 200 is performed. Note that the installation 200 is any of a new installation, a de-installation, or an installation of an update.

Upon receiving notice of the installation, the computer security system software 17 optionally checks to make sure 202 the software package is approved. If the installation is not approved 204, the installation is stopped 206.

If the installation is approved 204, the installation is allowed 208. The computer security system software 17 loads 250 the install file 52 and parses 252 the install file 52 to determine what programs (e.g., executables 56, scripts, macros, etc.) are being installed. The computer security system software 17 addresses the first object 260 from the install file 52. Note that it is anticipated that many objects are installed, only some of which are programs.

If the object is a program 262 (e.g., an executable, script, macro, etc.), the computer security system software 17 determines if the object is being added or deleted. If the object is not being added, the object is deleted 266 from the whitelist 19. If the object is being added 264, the object (e.g., program) is added 268 to the whitelist 19.

The computer security system software 17 selects the next installation object 270 and if there are more 272 installation objects, the above is repeated until there are no more 260 installation objects and the program is done.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for computer security running on a processor of a protected device having a processor, the system comprising:
when the system for computer security determines that an installation is being performed on the protected device, the system for computer security analyzes an installation file that controls the installation being performed on the protected device and, for each program being installed by the installation, the system for computer security adds an entry to a whitelist that allows execution of the program that is being installed and for each program being deleted by the installation, the system for computer security removes any previous entry from the whitelist; and
after the installation is complete, all of the programs that were installed by the installation are referenced in the whitelist and are allowed to execute.

2. The system for computer security of claim 1, wherein the program is an executable.

3. The system for computer security of claim 1, wherein the program is a script.

4. The system for computer security of claim 1, wherein the program is a macro.

5. A system for computer security running on a processor of a protected device that has a processor, the system comprising:
when the system for computer security determines that an installation is being performed on the protected device, the system for computer security adds a reference to an installation file that controls the installation being performed on the protected device to a whitelist; and
after the installation is complete, when a program attempts to run on the protected device, the system for computer security detects the reference to the installation file in the whitelist and parses the installation file to determine if the program was installed by the installation and if the program was installed by the installation, the program is allowed to run.

6. The system for computer security of claim 5, wherein the program is an executable.

7. The system for computer security of claim 5, wherein the program is a script.

8. The system for computer security of claim 5, wherein the program is a macro.

9. A method of synchronizing a whitelist with an installation on a protected device, the method comprising:
detecting an installation;
determining which programs are affected by the installation by parsing an installation file;
adding programs that are being installed by the installation to the whitelist;
removing programs that are being deleted by the installation from the whitelist; and
updating an entry in the whitelist for a program that is being modified by the installation.

10. The method of claim 9, wherein the detecting of the installation is performed by finding a signature for a well-known installer in the installation file.

11. The method of claim 9, wherein the detecting of the installation is performed by reading a certificate of a signed executable that performs the installation with respect to a process privilege of the signed executable to recognize when the signed executable that performs the installation has authorization to modify a filesystem of the protected device.

12. The method of claim 9, wherein the detecting of the installation is performed by analyzing metadata of files that the installation places in a storage of the protected device to correlate the files to previously installed files.

13. The method of claim 9, wherein the detecting of the installation is performed by manually classifying each possible installer by a researcher.

14. The method of claim 9, wherein the detecting of the installation is performed by providing a custom signing certificate that indicates which programs are approved.

15. The method of claim 9, wherein the programs are executables.

16. The method of claim 9, wherein the programs are scripts.

17. The method of claim 9, wherein the programs are macros.
